(19) United States
(12) Patent Application Publication
(10) Pub. No.: US 2007/0239555 A1
(43) Pub. Date: Oct. 11, 2007

(54) Method of marketing, exhibiting and selling artwork

(76) Inventor: Kipton Cronkite, New York, NY (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 11/390,532

(22) Filed: Mar. 28, 2006

(51) Int. Cl. G06Q 30/00

(52) U.S. Cl. 705/26

(57) ABSTRACT

A unique and effective method for bringing together artists and parties interested in viewing and possibly buying artwork, requires artists who wish to display their artwork and relevant background information to first submit application to the website system's administrator. If approved, the artist is so advised and is then permitted to upload artwork images to the system's images website. This allows those parties interested in the artwork, i.e. art dealers, collectors, galleries, and the general public, to subscribe to the system to secure access to the online information and artwork. In order for such interested parties to access the website and hence the artists' works and details online, they too must first register. At this point, the administrator is able to track all online activity, especially the artwork which is being viewed online. This coordinated site thus not only permits viewing of artwork, but appointments with the artists can be made, inquiries can be addressed, and purchases arranged.

### BACKGROUND OF THE INVENTION

Conducting business and other varied types of commerce over the worldwide web, particularly e-commerce over the internet, has become exceedingly popular over the last decade. The selling of all manner of products and merchandise over the internet through a myriad number of websites, in particular, has become the norm for the marketing and sale of products. Online websites provide the consumer with shop-at-home convenience and extraordinary purchasing power. Significantly, online systems not only provide consumers with access to products and services which otherwise would not be available to the general public, but they also provide a vast forum for vendors to exhibit, market, and sell. Just about any product or service which is available in the marketplace can be advertised, marketed, and sold over the internet.

### SUMMARY OF THE INVENTION

It is this internet technology and general public acceptance of the worldwide web as a marketing and sales medium which forms the basis for the unique e-commerce method of the subject invention. Specifically, the herein method provides both emerging and established artists a readily available platform to exhibit, market, and sell their artwork to collectors, dealers, gallery owners, and the general public. Moreover, the method provides any individual who has access to the internet a vehicle to view and purchase works of art which may otherwise be inaccessible to that person.

Emerging artists, especially, require a means to exhibit their artwork, in order to gain the necessary exposure to attract gallery owners and art dealers who could display their work. However, it is very difficult for these artists to gain the attention of artworld representatives who would be in a position to exhibit and sell their work. The very logistics of physically arranging exhibits, especially for artists who are distances away, is a problem. Fundamentally, there is just the plain lack of physical space for exhibitions of all artists who may be worthy of exhibiting. The herein method provides a unique, effective, and efficient means to bring together artists, collectors, gallery owners, art dealers, and the general public into one place, on an on-line secure website. It allows the artists, both young and more experienced alike, to be exposed and to exhibit and sell their artwork to the almost infinite marketplace provided by the internet.

These and other objectives are accomplished by the method of the present invention which requires that artists who wish to display their artwork, resume, and exhibition history and details online, first must submit application to the system's administrator for review. If approved, the artist is so advised and is then permitted to upload artwork images to the system's images website. This allows those parties interested in the artwork, i.e. art dealers, collectors, galleries, and the general public, to subscribe to the system in order to secure access to the online information and artwork. In order for such interested parties to access the website and hence the artists' works and details online, they too must first register. At this point, the administrator is able to track all online activity, especially the artwork which is being viewed online. This coordinated site thus not only permits viewing of artwork, but appointments with the artists can be made, inquiries can be addressed, and purchases arranged.

The novel features which are considered as characteristic of the invention are set forth in particular in the appended claims. The invention itself, both as to its design, construction, and use, together with additional features and advantages thereof, are best understood upon review of the following detailed description with reference to the accompanying drawings.

### BRIEF DESCRIPTION OF THE DRAWINGS

FIG. 1 is a schematic representation of the relationship of the artwork interested parties to the online website employed in the method of the present invention.

FIG. 2 is a schematic representation of how the online website is employed in the method of the present invention.

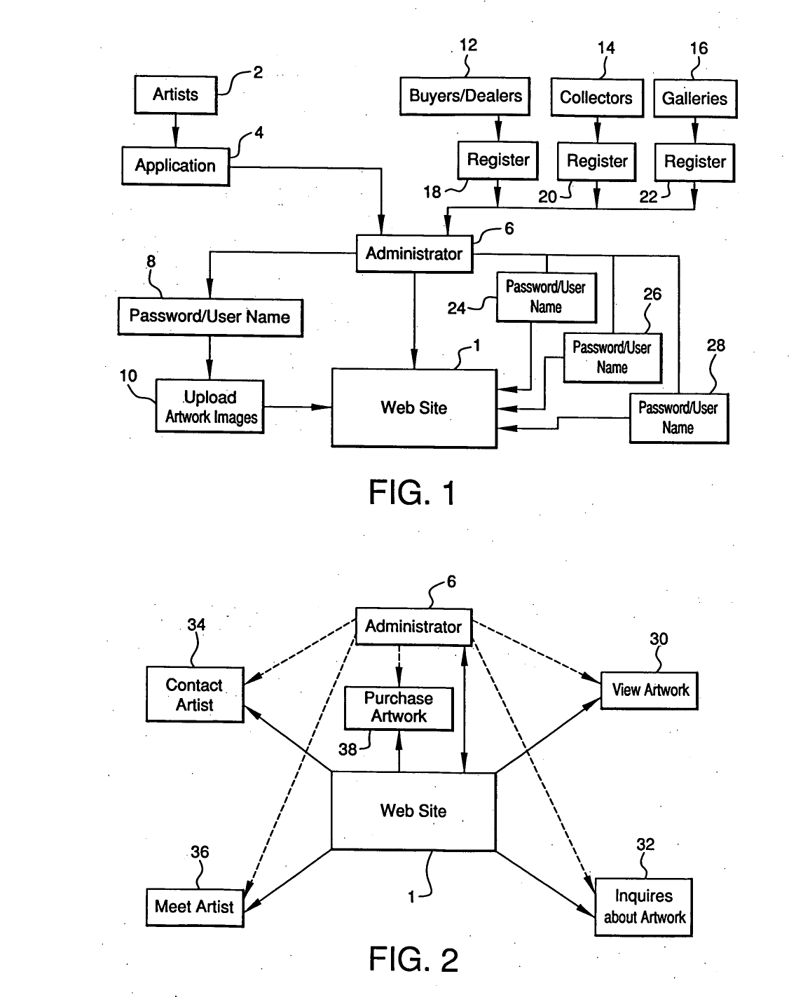

### DETAILED DESCRIPTION OF THE INVENTION

Website 1 provides the instrumentality for the coordination of the method used in bringing together artists and interested artwork collectors, galleries, and buyers—including dealers. Website 1 is a dynamic website system which is based on a database of supplied information. Such a system is well-know in the art.

Artists 2 who wish to display their artwork first must submit application 4 to the website system's administrator 6 for review. Application 4 requires the artists to provide their resume, exhibit history, and additional details online. The application must be detailed and complete, both in terms of identification of artists and appropriate quantity and quality of the artwork.

After review and approval by administrator 6, the artist is so notified, by e-mail or similar means. The artist is provided with a password and user name 8 and the ability to upload information to the website 1. The artist may then upload electronic artwork images and other information 10 to website 1. Uploaded artwork images are then received and aggregated for display on website 1.

Those parties interested in artwork, i.e. general public, including buyers/dealers 12, collectors 14 and galleries 16, are each required to register 18, 20, and 22 with administrator 6. An e-mail is sent to administrator 6 indicating that a new party has registered. Administrator 6 then assigns password/user names 24, 26, and 28 to those artwork interested parties 12, 14, and 16 which permit these parties to view the artwork online in website 1.

Once access is gained into website 1 buyers/dealers 12, collectors 14, and galleries 16 have the ability, through website 1, as depicted in FIG. 2, to view artwork 30, make inquiries about the artwork 32, contact the artist 34, and, if they are so inclined, meet the artist 36. Most significantly, website 1 permits purchase of the artwork 38 directly by buyers/dealers 12, collectors 14, and galleries 16. Administrator 6, as depicted in FIG. 2, has the ability, through website 1, to monitor and track all activity, 30, 32, 34, 36, and 38. Administrator 6 also has the ability to schedule meetings with the artists and generally be in a position to contact the artists and the interested artwork parties directly by e-mail.

Both experienced and especially emerging artists need a platform for the exhibition and marketing of their artwork for sale. Artists need a vehicle which provides them the necessary exposure to contact galleries or art dealers who may not have the ability to include them in their physical gallery space. Further, many artists do not have the experience in business dealings or pricing of artwork for sale. The method employed by the present invention provides this support to artists and is a convenient way for artists to focus on their art while being able to market the artwork to the interested public. Advantageously, as the number of artists and interested artwork public come online to website 1, the more interest there will be in the artwork and the number of artists and interested parties registering in the system will increase to the benefit of all.

Certain novel features and components of this invention are disclosed in detail in order to make the invention clear in at least one form thereof. However, it is to be clearly understood that the exact invention as disclosed is not necessary limited to the exact form and details as disclosed, since it is apparent that various modifications and changes may be made without departing from the spirit of the invention.

1. A method for marketing, exhibiting, and selling artwork over the internet, said method comprising the steps of:
providing a comprehensive website for exhibiting, marketing and selling artwork;
registering artists who desire to exhibit and sell their artwork;
authorizing artists to gain access to the website;
uploading electronic artwork images of the artists to the website;
receiving the uploaded electronic artwork images and aggregating the images for display on the website;
registering parties with an interest in viewing and potentially purchasing the artwork of the artists;
authorizing the interested parties to gain access to the website;
enabling the interested parties to retrieve and to view the electronic artwork images; and
permitting the interested parties to transmit feedback via electronic messaging, following the viewing of the electronic artwork images.

2. The method of marketing, exhibiting, and selling artwork as in claim 1 comprising the further step of transmitting an electronic message to the artists providing notice that they are authorized to gain access to the website.

3. The method of marketing, exhibiting, and selling artwork as in claim 1 further comprising the step of transmitting an electronic message to the interested parties providing notice that they are authorized to gain access to the website.

4. The method of marketing, exhibiting, and selling artwork as in claim 1 further comprising the step of assigning a password and user number to the artists to allow access to the website.

5. The method of marketing, exhibiting, and selling artwork further comprising the step of assigning a password and user number to the interested parties to allow access to the website.

6. The method of marketing, exhibiting, and selling artwork as in claim 1 wherein the interested parties comprise artwork collectors, artwork galleries, artwork dealers and potential buyers of artwork.

7. The method of marketing, exhibiting, and selling artwork as in claim 1 further comprising the step of providing a website system administrator to monitor the registration and participation of the artists and the interested parties.

8. The method of marketing, exhibiting, and selling artwork as in claim 7 further comprising the step of allowing the administrator full access to the website.

9. The method of marketing, exhibiting, and selling artwork as in claim 7 further comprising the step of transmitting e-mail messages from the artists to the website administrator to provide the administrator with notice of registration of the artists.

10. The method of marketing, exhibiting, and selling artwork as in claim 7 further comprising the step of transmitting e-mail messages from the interested parties to the website administrator to provide the administrator with notice of registration of registered parties.

11. The method of marketing, exhibiting, and selling artwork as in claim 7 further comprising the step of enabling the administrator to monitor the electronic artwork images being viewed by the interested parties.

12. The method of marketing, exhibiting, and selling artwork as in claim 7 further comprising the step of permitting the website administrator to electronically message artists and the interested parties to facilitate exhibition and sale of artwork of the artists.

13. The method of marketing, exhibiting, and selling artwork as in claim 1 further comprising the step of permitting the artists and the interested parties to electronically message each other to facilitate the display and sale of artwork of the artists.

14. The method of marketing, exhibiting, and selling artwork as in claim 7 further comprising the step of enabling the website administrator to monitor and respond to electronic messages between the artists and the interested parties.

15. The method of marketing, exhibiting, and selling artwork as in claim 1 further comprising the step of enabling the sale of artists' artwork viewed by the interested parties.

16. The method of marketing, exhibiting, and selling artwork as in claim 1 further comprising the step of enabling the artists to upload their electronic artwork images by supplying the artists with a password and user number.

17. The method of marketing, exhibiting, and selling artwork as in claim 1 further comprising the step of enabling the interested parties to retrieve the electronic artwork image by supplying the interested parties passwords and user numbers.

18. The method of marketing, exhibiting, and selling artwork as in claim 16 wherein the password and user numbers are assigned to the artists by the administrator.

19. The method of marketing, exhibiting, and selling artwork as in claim 16 wherein the password and user number is assigned to the interested parties by the administrator.
